(19) United States
(12) Patent Application Publication
(10) Pub. No.: US 2009/0087551 A1
(43) Pub. Date: Apr. 2, 2009

(54) Headlight and plastic surface repair composition and methodology

(76) Inventor: Thomas Owen Parsons, Frenchvale (CA)

Correspondence Address: Frank J. Bonini, Jr.;86 The Commons at Valley Forge East, 1288 Valley Forge Road, Post Office Box 750, Valley Forge, PA, 19482-0750, US

(21) Appl. No.: 12/284,175

(22) Filed: Sep. 19, 2008

(30) Foreign Application Priority Data
Oct. 1, 2007 (CA) 2,604,864

(51) Int. Cl. B05D 5/06; C09D 7/12

(52) U.S. Cl. 427/140; 106/287.25

(57) ABSTRACT

A method for repairing the damaged lens surface of a headlight lens, comprising the steps of, sanding the damaged lens surface of a headlight lens, applying a liquid composition to the sanded surface of the headlight lens and allowing the liquid composition to dry, wherein the liquid composition comprises a mixture of a urethane clearcoat, and an appropriate reducer. A damaged lens surface repair composition comprising a urethane clearcoat and an appropriate reducer thoroughly mixed together before application to the damaged lens surface.

### BACKGROUND OF THE INVENTION

1. Field of the Invention

The present invention relates to the repair of headlights, and more particularly relates to a composition and process used for the repair of headlights lenses of automobiles and other motor vehicles, and other polycarbonate plastic surfaces.

2. Brief Description of the Related Art

Headlights in many modern automobiles and other motor vehicles have two parts, a replaceable bulb (or in some cases, multiple replaceable bulbs), such as a halogen bulb which produces light from an electrical source, and a headlight housing in which the bulb is positioned, which headlight housing typically includes a mirrored or reflector surface to forwardly direct the light produced by the bulb, and a transparent or substantially transparent plastic (such as polycarbonate plastic or similar material) surface or lens through which the light passes (hereinafter referred to as the “headlight lens”).

Over time, the surface of the headlight lens may tarnish, oxidize, lose luster, become discolored or yellowed, or become hazy or less transparent (which damaged surface is hereinafter sometimes referred to as the “damaged lens surface”), either by exposure to sunlight, dirt, air, airborne particles or dust, as a result of which, the headlight's effectiveness is significantly reduced, potentially impairing or reducing the user's ability to see at night, and during inclement weather. Furthermore, as many jurisdictions require that headlights produce a predetermined amount of light at a predetermined distance, the loss of transparency of the headlight lens may result in the headlight becoming unusable, or unlawful to use in those jurisdictions. As headlight housings can be expensive to replace, it is desirable to provide a straightforward, quick and relatively inexpensive method for repairing the damaged lens surface of a headlight lens.

### SUMMARY OF THE INVENTION

Accordingly, one object of the present invention is to provide a straightforward and easy to implement method for repairing a damaged lens surface of a headlight lens or other polycarbonate plastic surface.

Accordingly, another object of the present invention is to provide a quick and relatively inexpensive method for repairing a damaged lens surface of a headlight lens or other polycarbonate plastic surface.

According to one aspect of the present invention, there is provided a method for repairing the damaged lens surface of a headlight lens, comprising the steps of, sanding the damaged lens surface of a headlight lens, applying a liquid composition to the sanded surface of the headlight lens, and allowing the liquid composition to dry, wherein the liquid composition comprises a mixture of a at least urethane clearcoat, and an appropriate reducer.

According to another aspect of the present invention, there is provided a damaged lens surface repair composition comprising at least, a urethane clearcoat and an appropriate reducer thoroughly mixed together before application to the damaged lens surface.

According to another aspect of the present invention, there is provided a method for repairing a damaged plastic surface, comprising the steps of, sanding the damaged plastic surface; applying a liquid composition to the sanded surface; and allowing the liquid composition to dry, wherein the liquid composition comprises a mixture of at least urethane clearcoat, and an appropriate reducer.

According to another aspect of the present invention, there is provided a damaged plastic surface repair composition comprising, at least a urethane clearcoat and an appropriate reducer thoroughly mixed together before application to the damaged plastic surface.

The advantage of the present invention is that it provides a straightforward and easy to implement method for repairing a damaged lens surface of a headlight lens or other polycarbonate plastic surface.

Another advantage of the present invention is that it provides a quick and relatively inexpensive method for repairing a damaged lens surface of a headlight lens or other polycarbonate plastic surface.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

In a preferred embodiment of the present invention the headlight housing remains in the automobile, the area immediately around the headlight housing being masked or protected in an appropriate manner in a manner known to a person skilled in the art, to ensure that surfaces of the automobile proximate the headlight housing are not effected by the process hereinafter described. In an alternative embodiment of the present invention, the headlight housing may be removed from the automobile and positioned, for example, on a work table or stand away from the automobile.

In the preferred embodiment of the present invention, the damaged lens surface of a headlight lens is subjected to a very light, wet or dry, sanding, by for example, fine grit sandpaper, preferably 1500 grit sandpaper, it being understood that relatively finer or relatively coarser sandpaper or other abrasive devices may be utilized as would be known to a person skilled in the art.

Once the sanding step has been completed, all dust, dirt, grit and material sanded from the damaged lens surface of a headlight lens is carefully cleaned from the damaged lens surface of a headlight lens, using a cloth, vacuum, compressed air, or other techniques as would be known to a person skilled in the art.

Thereafter, a liquid composition, as more fully described herein, is preferably evenly applied onto the sanded surface of the headlight lens, the liquid composition preferably being lightly, thinly and evenly sprayed by way of, for example, a compressed air driven liquid paint spray nozzle, for example, of the type generally used in an automobile body repair shop, to form a thin film or coating of preferably uniform or substantially uniform thickness on the sanded surface of the headlight lens, it being understood that while it is preferable to utilize a compressed air driven liquid paint spray nozzle of the type generally used in a automobile body repair shop, alternative methods and devices known to a person skilled in the art may be utilized to apply the liquid composition onto the sanded surface of the headlight lens.

Once applied, the liquid composition of the present invention is permitted to dry (which, at room temperature, generally takes less than 10 minutes, and preferably takes less than 5 minutes). If the headlight housing was removed from the automobile, it may thereafter be reinstalled in the automobile. Thereafter, the now repaired headlight may be used in the normal manner.

In the preferred embodiment of the present invention, the liquid composition described herein comprises a mixture of urethane clearcoat such as, for example, DIMENSION® CLEARCOAT DC5000 high solid urethane clearcoat available through Sherwin-Williams Automotive Finishes Corporation, combined with an appropriate reducer such as, for example, DIMENSION® REDUCER DR633, or another appropriate reducer, preferably combined in the ratio of 1:1 (it being understood that in alternative embodiments of the present invention, alternative urethane clearcoat formulations and reducers, in a narrow range of different ratios, may alternatively be utilized). It is also understood that in one embodiment of the present invention, there is provided a composition consisting essentially of a mixture of urethane clearcoat combined with an appropriate reducer. As will be apparent to one skilled in the art, the phrase ‘consisting essentially of’ refers to the fact that additional components, for example, hardeners and the like may be added. That is, in some embodiments, the composition consists essentially of a mixture of urethane clearcoat combined with an appropriate reducer, although additional chemicals, such as for example but by no means limited to hardeners and the like may be added.

In one embodiment of the present invention, an aerosol spray can in which the liquid composition of urethane clearcoat and an appropriate reducer of the present invention is placed (along with an appropriate aerosol propellant), is made available for consumers in relatively small quantities for “single use”, or for convenient application of the liquid composition, by for example, the home mechanic or “do-it-yourself” individual.

While the present invention has been described with reference to the repair of the damaged lens surface of a headlight lens, it is understood that the present invention may be utilized in the context of the repair of other plastic surfaces, such as, for example, plastic windows, plastic deck panels, plastic traffic and streetlights, plastic greenhouse windows, plastic hockey rink “glass” panels, parking meter windows and other like plastic applications.

The present invention has been described herein with regard to preferred embodiments. However, it will be obvious to persons skilled in the art that a number of variations and modifications can be made without departing from the scope of the invention as described herein.

What is claimed is:

1. A method for repairing the damaged lens surface of a headlight lens, comprising the steps of:
a. sanding the damaged lens surface of a headlight lens;
b. applying a liquid composition to the sanded surface of the headlight lens; and
c. allowing the liquid composition to dry,
wherein the liquid composition comprises a mixture of at least urethane clearcoat, and an appropriate reducer.

2. A method according to claim 1, wherein the ratio of the urethane clearcoat and the appropriate reducer is 1:1.

3. A method according to claim 1, wherein the urethane clearcoat is a high solid urethane clearcoat.

4. A method according to claim 2, wherein the urethane clearcoat is a high solid urethane clearcoat.

5. A method according to claim 3, wherein the urethane clearcoat is DIMENSIONS CLEARCOAT DC5000 high solid urethane clearcoat.

6. A method according to claim 4, wherein the urethane clearcoat is DIMENSIONS CLEARCOAT DC5000 high solid urethane clearcoat.

7. A damaged lens surface repair composition comprising:
a. at least a urethane clearcoat and an appropriate reducer thoroughly mixed together before application to the damaged lens surface.

8. A damaged lens surface repair composition according to claim 7, wherein the ratio of the urethane clearcoat and the appropriate reducer is 1:1.

9. A damaged lens surface repair composition according to claim 7, wherein the urethane clearcoat is a high solid urethane clearcoat.

10. A damaged lens surface repair composition according to claim 8, wherein the urethane clearcoat is a high solid urethane clearcoat.

11. A damaged lens surface repair composition according to claim 7, wherein the urethane clearcoat is DIMENSION® CLEARCOAT DC5000 high solid urethane clearcoat.

12. A damaged lens surface repair composition according to claim 8, wherein the urethane clearcoat is DIMENSION® CLEARCOAT DC5000 high solid urethane clearcoat.

13. A method for repairing a damaged plastic surface, comprising the steps of:
a. sanding the damaged plastic surface;
b. applying a liquid composition to the sanded surface; and
c. allowing the liquid composition to dry,
wherein the liquid composition comprises a mixture of at least urethane clearcoat, and an appropriate reducer.

14. A damaged plastic surface repair composition comprising:
a. at least a urethane clearcoat and an appropriate reducer thoroughly mixed together before application to the damaged plastic surface.
